(19) United States
(12) Patent Application Publication
(10) Pub. No.: US 2013/0002513 A1
(43) Pub. Date: Jan. 3, 2013

(54) ANTENNA AND WIRELESS COMMUNICATION DEVICE

(75) Inventors: Yuya DOKAI, Nagaokakyo-shi (JP); Noboru KATO, Nagaokakyo-shi (JP)

(73) Assignee: MURATA MANUFACTURING CO., LTD., Nagaokakyo-shi (JP)

(21) Appl. No.: 13/613,021

(22) Filed: Sep. 13, 2012

Related U.S. Application Data
(63) Continuation of application No. PCT/JP2011/053656, filed on Feb. 21, 2011.

(30) Foreign Application Priority Data
Mar. 31, 2010 (JP) 2010-084008

(51) Int. Cl. H01Q 9/04

(52) U.S. Cl. 343/867

(57) ABSTRACT

An antenna and a wireless communication device which are suitable for an RFID system and in which radiation characteristics are prevented from being changed as a result of impedance adjustment are configured such that the antenna includes a first loop electrode that has an external shape of a regular polygon or circle and that includes a pair of open ends, feeding portions arranged inside the first loop electrode, a second loop electrode connected to the feeding portions, and a coupling electrode that couples the first loop electrode and the second loop electrode to each other. The wireless communication device is obtained by coupling the wireless communication element which processes a high-frequency signal to the feeding portions.

### BACKGROUND OF THE INVENTION

1. Field of the Invention

The present invention relates to antennas and wireless communication devices, and more specifically to antennas and wireless communication devices preferably for use in radio frequency identification (RFID) systems.

2. Description of the Related Art

In recent years, RFID systems have been commercialized as article information management systems. In RFID systems, non-contact communication through an electromagnetic field is performed between a reader/writer that generates an induction field and an RFID tag (also called a wireless communication device) attached to an article, whereby predetermined information is transmitted. This RFID tag includes a wireless IC chip that stores predetermined information and processes a predetermined wireless signal and an antenna (radiation body) that transmits and receives a high-frequency signal.

Japanese Unexamined Patent Application Publication No. 2007-96655 discloses an antenna for an RFID tag. In this antenna, which is a bent dipole antenna, impedance is adjusted by forming a slit near a feeding portion. Further, Japanese Unexamined Patent Application Publication No. 2008-160821 discloses an antenna that includes a first loop conductor pattern and second and third conductor patterns connected to the first conductor pattern. In this antenna, which receives circularly polarized waves through the first conductor pattern, impedance is adjusted through adjustment of the lengths of the second and third conductor patterns.

However, the antenna disclosed in Japanese Unexamined Patent Application Publication No. 2007-96655, in which a portion of the dipole antenna is used for impedance adjustment, has a problem in that radiation characteristics such as directivity and gain may be changed depending on a change in the shape of the slit caused by the adjustment. Further, the antenna disclosed in Japanese Unexamined Patent Application Publication No. 2008-160821, in which the first conductor pattern is directly electrically connected to the second and third conductor patterns and, hence, a portion of the first conductor pattern contributes to the impedance adjustment, has a problem in that radiation characteristics such as directivity and gain may be changed as a result of the adjustment, similarly to the antenna disclosed in Japanese Unexamined Patent Application Publication No. 2007-96655.

### SUMMARY OF THE INVENTION

Accordingly, preferred embodiments of the present invention provide an antenna and a wireless communication device, appropriate for RFID systems, in which radiation characteristics are prevented from being changed as a result of impedance adjustment.

An antenna according to a first preferred embodiment of the present invention includes a first loop electrode that has an external shape of a regular polygon or circle and that includes a pair of open ends, feeding portions arranged inside the first loop electrode, a second loop electrode connected to the feeding portions, and a coupling electrode that couples the first loop electrode and the second loop electrode to each other.

A wireless communication device according to a second preferred embodiment of the present invention includes a first loop electrode that has an external shape of a regular polygon or circle and that includes a pair of open ends, feeding portions arranged inside the first loop electrode, a second loop electrode connected to the feeding portions, a coupling electrode that couples the first loop electrode and the second loop electrode to each other, and a wireless communication element coupled to the feeding portions.

In the antenna, the first loop electrode functions as a radiation portion and the second loop electrode functions as an impedance matching portion. Since the first loop electrode and the second loop electrode are coupled to each other through the coupling electrode, independence of the first loop antenna and the second loop antenna is ensured. In other words, even when the second loop electrode is adjusted for impedance matching, the radiation characteristics of the first loop electrode, such as directivity and gain, are maintained.

The above and other elements, features, steps, characteristics and advantages of the present invention will become more apparent from the following detailed description of the preferred embodiments with reference to the attached drawings.

### BRIEF DESCRIPTION OF THE DRAWINGS

FIGS. 1A and 1B illustrate an antenna according to a first preferred embodiment of the present invention wherein FIG. 1A is a plan view and FIG. 1B is a diagram explaining functions.

FIG. 2 is a plan view illustrating an antenna according to a second preferred embodiment of the present invention.

FIG. 3 is a plan view illustrating an antenna according to a third preferred embodiment of the present invention.

FIG. 4 is a plan view illustrating an antenna according to a fourth preferred embodiment of the present invention.

FIG. 5 is a plan view illustrating an antenna according to a fifth preferred embodiment of the present invention.

### DETAILED DESCRIPTION OF THE PREFERRED EMBODIMENTS

Hereinafter, preferred embodiments of an antenna and a wireless communication device according to the present invention will be described with reference to the drawings. Note that identical elements and portions in the figures are denoted by the same reference symbols and duplicate descriptions thereof are omitted.

### First Preferred Embodiment

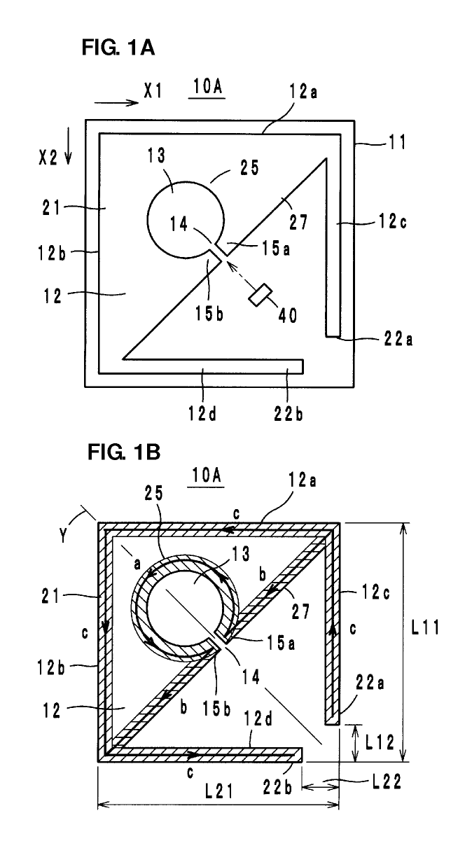

Referring to FIG. 1A, in an antenna 10A according to a first preferred embodiment, which is used for communication in the UHF band, a plate electrode 12 preferably having an external shape of a triangle, for example, is provided on the surface of a substrate 11 that is preferably square-shaped or substantially square-shaped. A resin film, such as a PET film, is preferably used as the substrate 11, for example. The plate electrode 12 preferably is a thin film conductor made of a metal foil such as a copper or aluminum foil, or is a thick film conductor made from conductive paste including silver or copper powder, for example.

In more detail, a first loop electrode 21 preferably has an external shape that is square-shaped or substantially square-shaped, and includes side portions 12a and 12b of the plate electrode 12 and line portions 12c and 12d that extend from the side portions 12a and 12b.

The tips of the line portions 12c and 12d include open ends 22a and 22b. A circular opening 13 and a slit portion 14 that communicates with the opening 13 are formed in the plate electrode 12. Opposing portions of the slit portion 14 define feeding portions 15a and 15b. The feeding portions 15a and 15b are located inside the first loop electrode 21 and are coupled to a wireless communication element 40.

The wireless communication element 40 preferably is an element in the form of a chip and processes a high-frequency signal. The wireless communication element 40 may be simply a wireless IC chip or may be formed as a feeding circuit substrate that includes a wireless IC chip and a resonant circuit having a predetermined resonant frequency. The wireless IC chip preferably includes a clock circuit, a logic circuit, a memory circuit, and the like and stores necessary information. The wireless communication element 40 may be directly electrically connected to or coupled through an electromagnetic field to the feeding portions 15a and 15b.

A second loop electrode 25 is located in a peripheral portion surrounding the opening 13 and the two ends thereof are connected to the feeding portions 15a and 15b. Coupling electrodes 27 are located at the periphery (specifically, bottom side portion) of the plate electrode 12 and couple the first loop electrode 21 and the second loop electrode 25 to each other.

Here, referring to FIG. 1B, to illustrate the first and second loop electrodes 21 and 25 and the coupling electrodes 27 so as to be easily recognizable, the first loop electrode 21 is a portion shaded with lines rising toward the right and the second loop electrode 25 is a portion shaded with lines falling toward the right. In addition, the coupling electrodes 27 are portions shaded with horizontal lines. The first loop electrode 21 and the second loop electrode 25 preferably are symmetrical or substantially symmetrical about a virtual straight line Y that passes through the open ends 22a and 22b and the feeding portions 15a and 15b. In other words, the first and second loop electrodes 21 and 25 are preferably line-symmetrical or substantially line-symmetrical about the virtual straight line Y that passes through the opposing apexes of the nearly square loop electrode.

In the antenna 10A configured as described above, a predetermined high-frequency signal output from the wireless communication element 40 is transmitted through the feeding portions 15a and 15b over the second loop electrode 25 (refer to an arrow a), is transmitted through the coupling electrodes 27 over the first loop electrode 21 (refer to arrows b and c), and is radiated outward from the first loop electrode 21. On the other hand, a high-frequency signal received by the first loop electrode 21 is transmitted over the second loop electrode 25 through the coupling electrodes 27, and is supplied to the wireless communication element 40 through the feeding portions 15a and 15b. As a result, communication with the reader/writer of an RFID system is achieved.

In other words, in the first preferred embodiment, the first loop electrode 21 functions as a radiation portion and the second loop electrode 25 functions as an impedance matching portion between the wireless communication element 40 and the first loop electrode 21. The impedance can be adjusted by adjusting the diameter or shape of the opening 13. Since the first loop electrode 21 and the second loop electrode 25 are coupled to each other through the coupling electrodes 27, independence of the first loop electrode 21 and the second loop electrode 25 is ensured. Specifically in the first preferred embodiment, it is preferred that the first loop electrode 21 is arranged in a peripheral portion, the second loop electrode 25 is arranged inside the first loop electrode 21, and the feeding portions 15a and 15b are arranged in the central portion of the first loop electrode 21. Hence, the distance between the first loop electrode 21 and the second loop electrode 25 and the distances between the first loop electrode 21 and the feeding portions 15a and 15b are large and, hence, there is a high degree of independence between the first loop electrode 21 and the second loop electrode 25 and between the first loop electrode 21 and the feeding portions 15a and 15b.

As a result, it is unlikely that the radiation characteristics (directivity, gain, etc.) of the first loop electrode 21 are influenced by the second loop electrode 25 or the feeding portions 15a and 15b. In other words, even when the second loop electrode 25 is adjusted for impedance matching, the radiation characteristics, such as directivity and gain, of the first loop electrode 21 are maintained. Further, transmission and reception of circularly polarized waves become possible by adjusting the arrangement of the open ends 22a and 22b of the first loop electrode 21.

Here, the fact that the first loop electrode 21 and the second loop electrode 25 are coupled to each other means that the two electrodes are electrically connected to each other through the coupling electrodes 27. The coupling is usually in the form of a DC direct connection, but the coupling may be magnetic coupling or electric field coupling, for example. Transmission and reception of circularly polarized waves become possible by setting the lengths of the line portions 12c and 12d to the same length (L11-L12=L21-L22). Further, good radiation characteristics are obtained by making the first and second loop electrodes 21 and 25 be respectively symmetrical or substantially symmetrical about the virtual straight line Y. In other words, in the first loop electrode 21, the voltage becomes maximum at the open ends 22a and 22b and the current becomes maximum along the virtual straight line Y. Similarly, in the second loop electrode 25, the current becomes maximum along the virtual straight line Y such that a high voltage can be applied between the feeding portions 15a and 15b.

In the antenna 10A, the first loop electrode 21 preferably is arranged so as to have an external shape that is square or substantially square. By making the external shape be a square or substantially square, a signal can be transmitted/received similarly in the vertical and horizontal directions (refer to arrows X1 and X2 in FIG. 1A) such that nearly non-directional transmission/reception is realized. Note that nearly non-directional transmission/reception may also be achieved when the first loop electrode 21 has an external shape of a circle or a regular polygon. The electrical lengths of portions of the first loop electrode 21 extending along the sides where the open ends 22a and 22b are provided are shorter than the lengths of the sides. This means that the first loop electrode 21 has a configuration in which the open ends 22a and 22b are provided. An area (null point) in which transmission/reception cannot be performed can be decreased by setting the electric lengths of the line portions 12c and 12d to be respectively longer than L12 and L22.

In the antenna 10A, it is preferable to make the electrical length of the first loop electrode 21 be about half of a wavelength X used in transmission and reception, for example. This allows the resonant characteristics to be improved. Further, since the antenna 10A is non-directional and the first loop electrode 21 includes the plate electrode 12, a high-frequency signal is also transmitted from and received by the plate portion such that the gain is increased.

### Second Preferred Embodiment

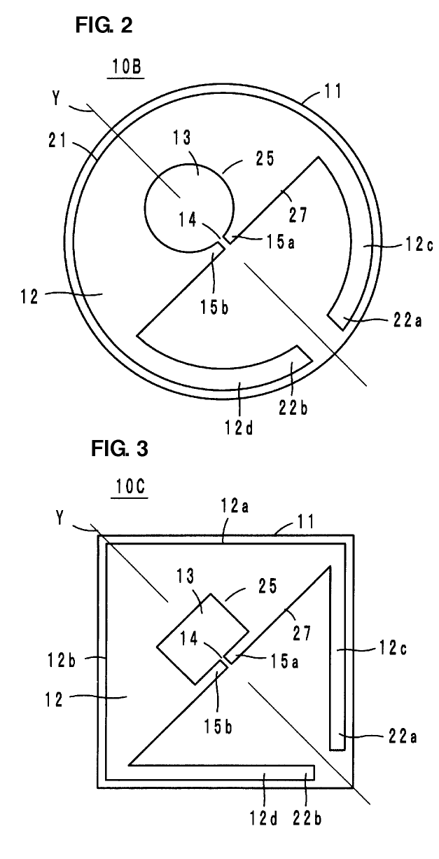

Referring to FIG. 2, an antenna 10B according to a second preferred embodiment has a configuration in which a plate electrode 12 preferably having a semicircular or substantially semicircular shape is located on the surface of a substrate 11 that is preferably circular or substantially circular. Line portions 12c and 12d extend from the two ends of the peripheral portion of the plate electrode 12 in such a manner as to form a concentric circle. A circular or substantially circular opening 13 and a slit portion 14 that communicates with the opening 13 are formed in the plate electrode 12. Opposing portions of the slit portion 14 define and function as feeding portions 15a and 15b.

In the second preferred embodiment, a first loop electrode 21 is arranged such that the peripheral portion and the line portions 12c and 12d of the plate electrode 12 define a circle. The tips of the line portions 12c and 12d are open ends 22a and 22b. A second loop electrode 25 is provided in a peripheral portion surrounding the opening 13 and the two ends thereof are connected to feeding portions 15a and 15b. Similarly to the first preferred embodiment, the wireless communication element 40 is coupled to the feeding portions 15a and 15b. Coupling electrodes 27 are located in the straight line portion of the plate electrode 12 and couples the first loop electrode 21 and the second loop electrode 25 to each other.

The operations of the first loop electrode 21, the second loop electrode 25, and the coupling electrodes 27 in the second preferred embodiment are similar to those of the first preferred embodiment described above, and the functions and the effects are also similar to those of the first preferred embodiment.

### Third Preferred Embodiment

Referring to FIG. 3, an antenna 10C according to a third preferred embodiment has a configuration in which an opening 13 preferably is rectangular or substantially rectangular. The rest of the configuration and the functions and the effects are similar to those of the first preferred embodiment described above.

### Fourth Preferred Embodiment

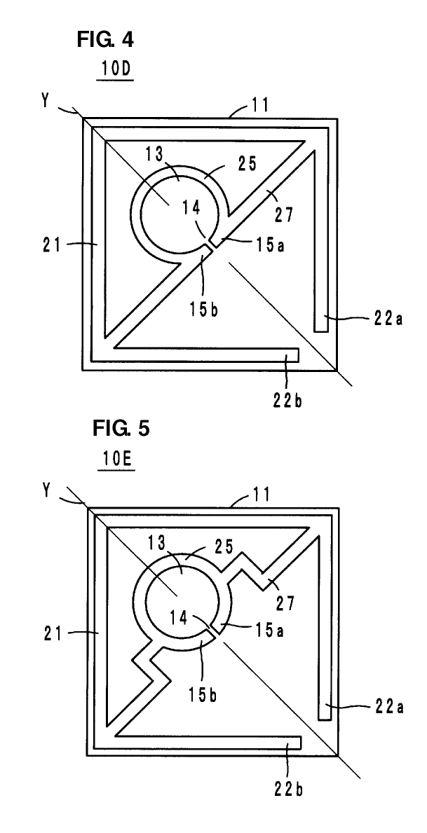

Referring to FIG. 4, an antenna 10D according to a fourth preferred embodiment has a configuration in which a first loop electrode 21, a second loop electrode 25, and coupling electrodes 27 are respectively defined by line conductors. The functions and effects of respective portions are similar to those of the first preferred embodiment described above.

### Fifth Preferred Embodiment

Referring to FIG. 5, an antenna 10E according to a fifth preferred embodiment has a configuration in which a first loop electrode 21, a second loop electrode 25, and coupling electrodes 27 are respectively defined by line conductors. The functions and effects of respective portions are similar to those of the first preferred embodiment described above. Specifically in the fifth preferred embodiment, the connection portions between the coupling electrodes 27 and the second loop electrode are arranged at positions that are spaced apart from the feeding portions 15a and 15b. By changing the positions of the connection portions between the coupling electrodes 27 and the second loop electrode 25 in this manner, impedance can be adjusted. Further, the degree of independence of the first loop electrode 21 and the second loop electrode 25 can be increased by increasing the lengths of the coupling electrodes 27.

### Other Preferred Embodiments

Note that the antenna and wireless communication device according to the present invention are not limited to the preferred embodiments described above and can be modified in various ways within the scope of the present invention.

For example, although a wireless communication element in the form of a chip preferably is mounted on the feeding portions of an antenna in the preferred embodiments described above, by providing the wireless communication element on a substrate that is different from the substrate on which the loop electrode is provided, the wireless communication element may be connected to the feeding portions through connection paths such as flexible lines. Further, this antenna can be used not only as an antenna for an RFID tag but also as an antenna for a reader/writer or as an antenna for other communication systems, such as GSM and GPS, for example.

As described above, preferred embodiments of the present invention are useful for antennas and wireless communication devices, and specifically provide an advantage in that radiation characteristics are prevented from being changed as a result of impedance adjustment.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna comprising:
a first loop electrode that has an external shape of a regular polygon or circle and that includes a pair of open ends;
feeding portions arranged inside the first loop electrode;
a second loop electrode connected to the feeding portions; and
a coupling electrode that couples the first loop electrode and the second loop electrode to each other.

2. The antenna according to claim 1, wherein the feeding portions are arranged in a substantially central portion of the first loop electrode.

3. The antenna according to claim 1, wherein the first loop electrode and the second loop electrode have respective shapes that are symmetrical or substantially symmetrical about a virtual straight line passing through the open ends and the feeding portions.

4. The antenna according to claim 1, wherein the first loop electrode has an external shape that is square or substantially square.

5. The antenna according to claim 4, wherein an electrical length of a portion of the first loop electrode along a side where the open end is provided is shorter than a length of the side.

6. The antenna according to claim 1, further comprising:
a plate electrode that includes an opening and a slit portion that communicates with the opening; wherein
the coupling electrode and a portion of the first loop electrode are located in a peripheral portion of the plate electrode;
the second loop electrode is located in a peripheral portion surrounding the opening; and
opposing portions of the slit portion define the feeding portions.

7. The antenna according to claim 6, further comprising a substrate that is square or substantially square, wherein the plate electrode is located on the plate and has an external shape that is triangular or substantially triangular.

8. The antenna according to claim 6, further comprising a substrate that is circular or substantially circular, wherein the plate electrode is located on the plate and has an external shape that is semicircular or substantially semicircular.

9. The antenna according to claim 6, wherein the opening has a shape that is circular or substantially circular.

10. The antenna according to claim 6, wherein the opening has a shape that is square or substantially square.

11. The antenna according to claim 6, wherein the opening has a shape that is rectangular or substantially rectangular.

12. The antenna according to claim 1, wherein an electrical length of the first loop electrode is about half of a wavelength of a signal received or transmitted by the antenna.

13. The antenna according to claim 1, wherein the first loop electrode defines a radiation portion and the second loop electrode defines an impedance matching portion.

14. The antenna according to claim 1, wherein the first loop electrode and the second loop electrode are independent from each other such that adjustment of the second loop electrode does not affect the first loop electrode.

15. The antenna according to claim 1, wherein the first loop electrode, the second loop electrode, and the coupling electrode are respectively defined by line conductors.

16. The antenna according to claim 15, wherein a connection portion between the coupling electrode and the second loop electrode is located at a position that is spaced apart from the feeding portions.

17. A wireless communication device comprising:
a first loop electrode that has an external shape of a regular polygon or circle and that includes a pair of open ends;
feeding portions arranged inside the first loop electrode;
a second loop electrode connected to the feeding portions;
a coupling electrode that couples the first loop electrode and the second loop electrode to each other; and
a wireless communication element coupled to the feeding portions.

18. The wireless communication device according to claim 17, wherein the wireless communication element is mounted on the feeding portions.

19. The wireless communication device according to claim 17, wherein the wireless communication element is a chip component.

20. The wireless communication device according to claim 17, further comprising a substrate, wherein the wireless communication element is mounted on the substrate and connected to the feeding portions through connection paths.
